(19) United States
(12) Patent Application Publication
(10) Pub. No.: US 2010/0128486 A1
(43) Pub. Date: May 27, 2010

(54) Light emitting illuminant

(76) Inventor: Wu-Te Peng, Pingjien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,772

(22) Filed: Nov. 26, 2008

(51) Int. Cl. F21V 99/00

(52) U.S. Cl. 362/311.1

(57) ABSTRACT

A light emitting illuminant improves a cover of a conventional light emitting device by designing the internal surface of the cover with an irregular serrated surface, such that after a strong light source of the light emitting device is projected onto the internal surface of the cover, the wavelength and the reflecting/refraction direction of the light source are changed to achieve a mixed light effect and overcome an eyesore effect of the strong light source. The external surface of the cover is designed in an arc shape and with a thickness different from that of the internal surface to constitute a lens mode, such that after the lights of the light source are mixed through the internal surface, the lens with the property of focusing/scattering lights can change the wavelength to amplify and mix the lights, so as to provide a high brightness for the light source.

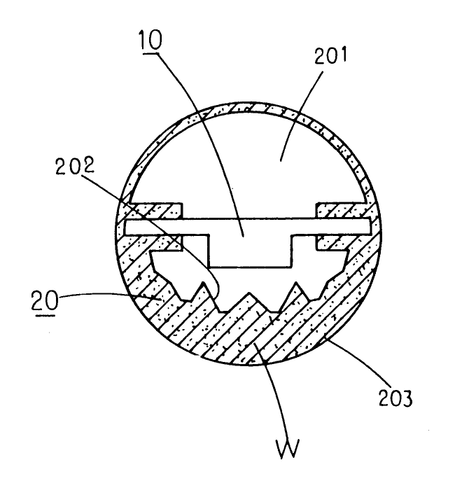

### BACKGROUND OF THE INVENTION

1. Field of the Invention

The present invention relates to a light emitting illuminating apparatus, and more particularly to a light emitting illuminant that features a simple installation and an easy and convenient application, and is capable of providing a strong light source to a light emitting device and changing the wavelength and direction of a mixed light to improve the eyesore effect of a light source, and amplify the wavelength of a focused/scattered light of the mixed light source or mix the light, so as to achieve a high brightness of the light source, and improve over the prior art.

2. Description of the Related Art

In general, most covers of a light emitting device have smooth surface on both internal and external sides of the covers and an even thickness. The brightness of a light emitted from a light emitting device having a lower-intensity light source (such as a fluorescent lamp tube or a tungsten light bulb) falls within a comfortable range, but a light emitted from a light emitting device with a higher-intensity light source (such as an LED lamp or a projector lamp) will be too bright and produce an eyesore effect. If other covers are added to improve the eyesore effect, the brightness of the light source will be reduced.

### SUMMARY OF THE INVENTION

In view of the shortcomings of the prior art, the inventor of the present invention based on years of experience in the related industry to conduct extensive researches and experiments, and finally developed a light emitting illuminant in accordance with the present invention to overcome the shortcomings of the prior art.

Therefore, it is a primary objective of the invention to provide a light emitting illuminant that features a simple installation and an easy and convenient application, and is capable of providing a strong light source to a light emitting device and changing the wavelength and direction of a mixed light to improve the eyesore effect of a light source, and amplify the wavelength of a focused/scattered light of the mixed light source or mix the light, so as to achieve a high brightness of the light source, and improve over the prior art.

Another objective of the present invention is to provide a light emitting illuminant having the features of a low manufacturing cost and a safe application.

To achieve the foregoing objectives, the present invention provides a light emitting illuminant that improves a cover of a conventional light emitting device by designing the internal surface of the cover with an irregular serrated surface, such that after a strong light source of the light emitting device is projected onto the internal surface of the cover, the wavelength and the reflecting/refraction direction of the light source are changed to achieve a mixed light effect and overcome an eyesore effect of the strong light source. The external surface of the cover is designed in an arc shape and with a thickness different from that of the internal surface to constitute a lens mode, such that after the lights of the light source are mixed through the internal surface, the lens with the property of focusing/scattering lights can change the wavelength to amplify and mix the lights, so as to provide a high brightness for the light source.

### BRIEF DESCRIPTION OF THE DRAWING

The FIGURE is a cross-sectional view of a preferred embodiment of the invention.

### DETAILED DESCRIPTION OF THE PREFERRED EMBODIMENTS

To make it easy for our examiner to understand the objects, characteristics and effects of the present invention, we use preferred embodiments with a related drawing for the detailed description of the present invention as follows:

With reference to the FIGURE for a cross-sectional view of a light emitting illuminant in accordance with a preferred embodiment of the invention, the light emitting illuminant improves a cover 20 of a light emitting device 10, wherein the cover 20 is made of a transparent material and includes a hollow containing portion 201 for receiving a light emitting device 10 (such as an LED), a plurality of irregular serrated surfaces 202 on the internal surface corresponding to a light source emitted from the light emitting device 10, and the external surface 203 is in an arc shape, and the thickness W between the external surface 203 and the internal surface 202 of the cover 30 varies to form a lens mode, wherein the thickness between the internal and external surfaces 202, 203 of the cover 20 is larger at the position where the light emitting device 10 emits the light source and becomes progressively thinner to the periphery of the cover.

With the structure formed by the foregoing components, the irregular serrated surfaces on the internal surface of the cover 20 reflect or refract a strong light source to change the wavelength and the direction of the mixed light when the light source emitted from the light emitting device 10 is projected onto the internal surface of the cover 20. The light will not be reflected directly to the outside, and such arrangement can improve the eyesore effect of the strong light source. Since a lens mode is formed between the internal and external surfaces 202, 203 of the cover 20, the eyesore effect of the light source will be eliminated after the lights are mixed by the serrated surfaces 202 on the internal surface of the cover 20, and the lens mode can amplify the wavelength of the focused and scattered lights to further improve the brightness of the light source.

Of course, both size and quantity of the serrated surfaces on the internal surface of the cover 20 can be varied depending on the intensity of the light source emitted from the light emitting device 210, and the cover 20 having the serrated internal surfaces and the lens mode can come with a plurality of covers stacked with each other for mixing the lights of the light source of the light emitting device 10 for several times.

In addition, the cover 20 is preferably made of an artificial crystal material to produce a prism effect and achieve a soft light effect.

What is claimed is:

1. A light emitting illuminant, having a light emitting device and a cover, and characterized in that the cover is made of a transparent material and comprises a hollow containing portion for receiving the light emitting device, a plurality of serrated surfaces disposed on an internal surface of the cover and corresponding to a light source emitted from the light emitting device, and external surface of the cover is an arc surface, and the thickness between the external and internal surfaces of the cover varies to constitute a lens mode.

2. The light emitting illuminant of claim 1, wherein the thickness between the internal and external surfaces of the cover is larger at a position where the light emitting device emits the light source, and becomes progressively thinner towards the periphery of the cover.

3. The light emitting illuminant of claim 1, wherein the cover is preferably made of an artificial crystal material.

4. The light emitting illuminant of claim 1, wherein the cover with a serrated internal surface and a lens comes with a plurality of covers stacked with each other.
